(19) United States
(12) Patent Application Publication
(10) Pub. No.: US 2011/0154645 A1
(43) Pub. Date: Jun. 30, 2011

(54) APPARATUS FOR FORMING A KINEMATIC COUPLING AND RELATED METHODS

(76) Inventor: Christopher J. Morgan, Louisville, KY (US)

(21) Appl. No.: 13/060,887

(22) PCT Filed: Aug. 25, 2009
(86) PCT No.: PCT/US2009/054900

§ 371 Date: Feb. 25, 2011

Related U.S. Application Data
(60) Provisional application No. 61/190,177, filed on Aug. 26, 2008.

(51) Int. Cl. B23P 11/00; B23P 19/04

(52) U.S. Cl. 29/428; 29/724

(57) ABSTRACT

In one aspect, an apparatus for use in forming a kinematic coupling having at least one component including a plate adapted for carrying a plurality of bearing elements comprises a template including a plurality of supports adapted for engaging and assisting in aligning the plurality of bearing elements relative to the plate of the component. The template may be used in forming either a top or base of the kinematic coupling. The top may further be adapted to be inverted relative to the base, which may also include bearing elements for receiving bearing elements associated with the top. Related methods are also disclosed.

This application claims the benefit of U.S. Provisional patent application Ser. No. 61/190,177, filed Aug. 26, 2008, the disclosure of which is incorporated herein by reference.

### TECHNICAL FIELD

The present invention relates to the art of precision manufacturing and, more particularly, to an apparatus for forming quasi-kinematic or kinematic couplings and related methods.

### BACKGROUND OF THE INVENTION

In its most basic form, a kinematic coupling is a device comprised of two plates, one fixed (the base) and one that is portable or removable (the top). The main feature of a kinematic coupling is the ability of the top to be separated from the base and then to be precisely returned to the base. A kinematic coupling achieves this by constraining all six degrees of mechanical freedom between the base and top with exactly six Hertzian contact points.

Kinematic couplings are typically used in manufacturing processes and are particularly useful in those where precision, or repeatability, is essential. In the present art, high precision exists only between a single unique kinematic coupling base/top pair. When one places a different coupling top on the same base, the position of the bearing elements on the new coupling top is different with respect to the base. That is, coupling tops are not accurate with respect to one another although the position of each top with respect to a given base is precise, or repeatable; it is not, however, accurate. (Correspondingly, the same result holds true if one were to exchange bases rather than tops.) This uniqueness means the tops (and correspondingly, bases) are not interchangeable.

In the present art, interchangeability between different coupling tops and bases without a loss of positional accuracy has been a long-standing problem. Interchangeability with high accuracy is desirable in fields such as micromanufacturing, micromachining, micromolding, precision optics and precision engineering, to name but a few. Interchangeability in these fields is desirable so that multiple work-pieces can be mounted on different coupling tops and moved through manufacturing/metrology processes on a plurality of coupling bases while maintaining the accurate location of the work-piece with respect to each base. Interchangeable kinematic (and quasi-kinematic) coupling bases and tops would solve a longstanding problem in precision engineering and eliminate time consuming calibrations as is presently done, thereby enhancing manufacturing efficiency and overall accuracy of the production environment.

Past approaches to creating interchangeable kinematic couplings generally suffer from being very complex, extremely expensive and still do not sufficiently reach the touchstone of high accuracy in interchangeability. For example, some systems attempt to create accurate interchangeability using complex measurement and calibration systems. This results in a loss of production efficiency and leads to poor accuracy. Although the preceding mainly refers to kinematic couplings, it applies equally to quasi-kinematic couplings, which are likewise useful in production facilities.

Accordingly, there exists a need for an apparatus and method by which a plurality of kinematic or quasi-kinematic couplings may be manufactured in a manner that promotes accurate interchangeability. As compared with past approaches, the resulting coupling should be relatively simple in construction and inexpensive to implement. In doing so, it would bring a significant level of advancement in terms of accuracy, reducing the cost of such couplings and reducing a manufacturer's processing costs in practice.

### SUMMARY OF THE INVENTION

The apparatus and manufacturing method described herein result in the creation of substantially identical and, therefore, accurately interchangeable kinematic/quasi-kinematic coupling bases and tops. This is accomplished by utilizing novel templates for forming coupling tops and bases and a corresponding heretofore undiscovered manufacturing method.

To achieve accurate interchangeability, each coupling top is formed utilizing a novel top template and each coupling base is formed using a novel base template. The accuracy of the coupling bases and tops is ensured by using the templates to position bearing elements of the coupling bases and tops, and kinematically constraining each bearing element, and fixing it in place with respect to a plate. Thus, it is unnecessary to position these elements by physical measurement to achieve high accuracy, as this is a natural and inherent result of the manufacturing method.

Summarizing the disclosed embodiments, a first aspect of the disclosure relates to an apparatus for forming a kinematic coupling component including a plate adapted for carrying a plurality of bearing elements. The apparatus comprises a template including a plurality of supports adapted for engaging and assisting in aligning the plurality of bearing elements relative to the plate of at least one component of the kinematic coupling.

In the preferred embodiment, the plurality of supports are adapted to be in Hertzian contact with at least one bearing element, which may be spherical. Accordingly, a surface of each support is generally convex and, most preferably, spherical. The at least one support may comprise three generally spherical shapes, and a frame of the template may comprise at least one generally circular cut-out for receiving the three generally spherical shapes, arranged in a generally triangular pattern. The supports may be fixed in position by a fixing agent, such as an adhesive or brazing. The supports may also be are arranged in a generally triangular pattern (such as with two sides of equal length).

In an alternative embodiment, at least one of the supports comprises six generally spherical shapes, and is thus adapted to engage a cylindrical bearing element. In such case, the frame may be provided with at least one generally rectangular cut-out for receiving the six generally spherical shapes. As in the embodiment described above, the supports may be fixed in position with a fixing agent. The supports may also be are arranged in a generally triangular pattern.

In any embodiment, the frame includes a planar structure for engaging the supports. Most preferably, the planar structure comprises granite. A planar reference structure may also be provided for aligning the plate of the component relative to the template. The planar reference structure is preferably parallel to the planar structure, and may comprise at least one gage block for placing on the planar structure.

Another aspect of the disclosure relates to an apparatus comprising a first component for forming a kinematic coupling including a plate having a plurality of bearing elements. Each bearing element is adapted for engaging at least one of the bearing elements of a second, opposing component. The bearing elements are fixed to the plate in a manner that creates parallelism between a work surface on the plate and a plane intersecting the geometric centers of the bearing elements.

In one embodiment, the plurality of bearing elements of the first component is engaged in Hertzian contact with the plurality of bearing elements on the second component. Preferably, the one or more of the bearing elements include a generally convex surface and, most preferably, a generally spherical surface. The plurality of bearing elements may comprise three generally spherical surfaces, which have geometric centers forming a triangle (which includes at least two sides of equal length).

In one particular embodiment, the one or more of bearing elements protrude from the plate in two generally opposing directions. More preferably, the one or more of the bearing elements protrude symmetrically from the plate about a plane parallel to a work surface of the component.

The plate preferably includes through holes for receiving the bearing elements. A fixing agent may be used for securing the bearing elements to the plate, which may be generally circular in shape. The bearing elements may be arranged to form a groove, and may include two generally cylindrical surfaces. Most preferably, the bearing elements form three grooves, and/or generally form a triangle.

A further aspect of the disclosure relates to a method for forming a kinematic component having a plate adapted for carrying a plurality of bearing elements. The method comprises providing a template including a plurality of supports adapted for assisting in aligning the plurality of bearing elements relative to the plate of the component and fixing the bearing elements to the plate.

The at least one component may comprise a first component, and the method may further include the step of using the template to align the plurality of bearing elements relative to the plate of a second kinematic component. Preferably, the method comprises providing the plurality of supports having a generally convex surface, and most preferably with a spherical surface. The method may comprise engaging the plurality of supports with a generally convex bearing element. The method may further include establishing Hertzian contact between the plurality of supports and a generally convex bearing element, such as a spherical bearing element.

The method may further include the step of urging at least one of the spherical towards another to comprise a support. The supports may also be arranged in a triangle with at least two sides of equal length. The supports may be arranged with an associated groove formed by one or more of the bearing elements, such as by engaging one or more of the supports with two generally cylindrical bearing elements.

The fixing step may comprise using a fixing agent, such as an adhesive or brazing. The method may further include the step of supporting the plate of the component relative to the template. This may in one embodiment of the method involve the step of arranging a surface on the plate in parallel with the plane comprising the geometric center of the bearing elements. This method may include aligning the centers of the plurality of bearing elements by placing the bearing elements in Hertzian contact with the plurality of supports. Aligning may comprise aligning a work surface of the component and the planar reference structure of the template. The method may also include positioning at least one gage block between the planar structure and the work surface of the plate.

Another aspect of the disclosure relates to a kinematic coupling comprising at least one top for associating with the base. The top includes a plurality of first bearing elements projecting in a first direction. Each first bearing element may be adapted for engaging the base, and a plurality of second bearing elements project in a second direction generally opposite the first direction.

### BRIEF DESCRIPTION OF THE DRAWINGS

FIG. 1a is a perspective view of a kinematic coupling according to one aspect of the disclosure;

FIG. 1b is a partially exploded view of the kinematic coupling of FIG. 1a;

FIGS. 2a and 2b are perspective and top views, respectively, of a template for use in forming a kinematic coupling top;

FIG. 3 illustrates the template of FIGS. 2a and 2b for forming a kinematic coupling top;

FIGS. 4a and 4b are perspective and top views, respectively, of a template for use in forming a kinematic coupling base; and

FIG. 5 illustrates the template of FIGS. 4a and 4b for forming a kinematic coupling base.

### DETAILED DESCRIPTION OF INVENTION

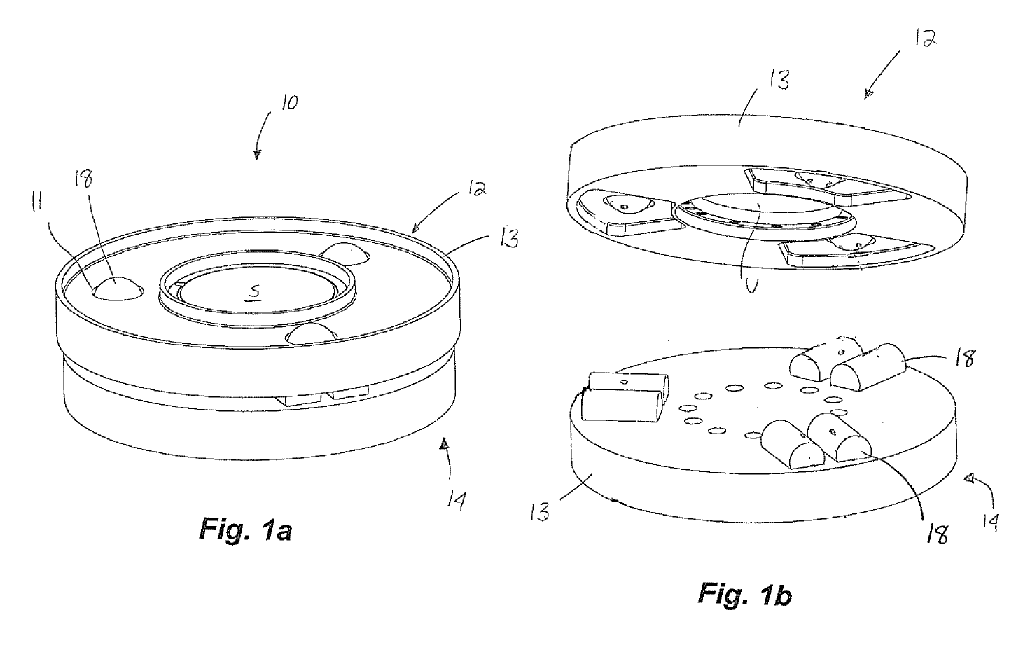

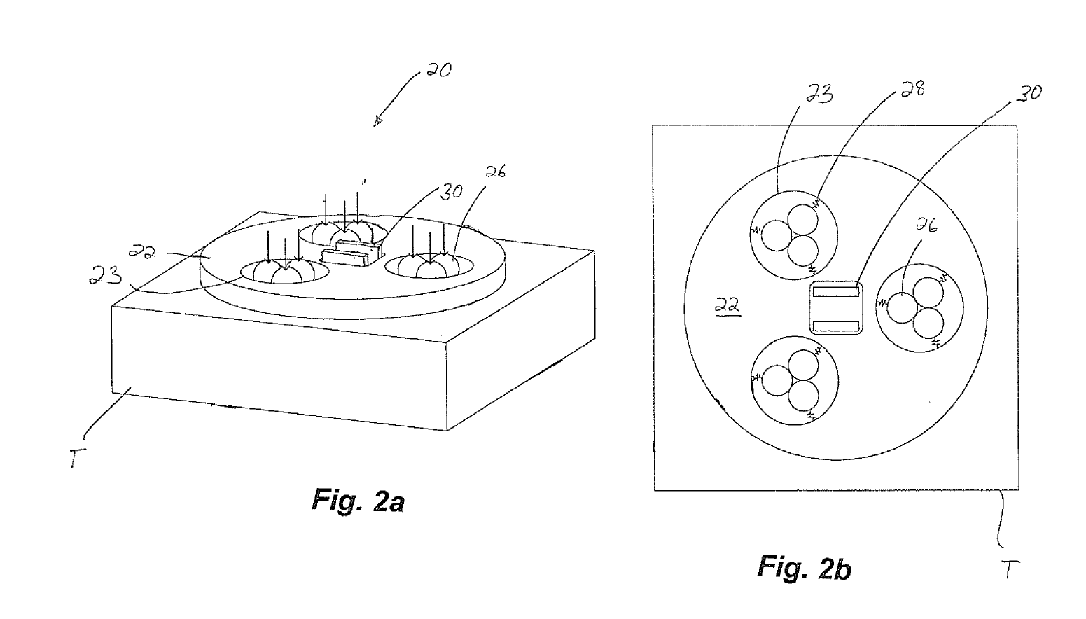

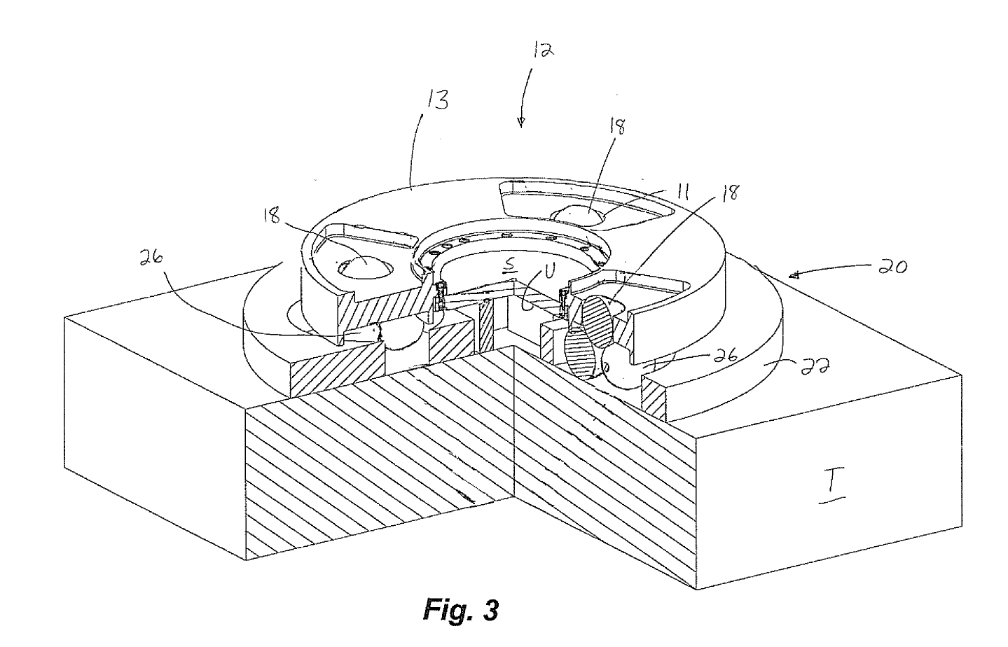

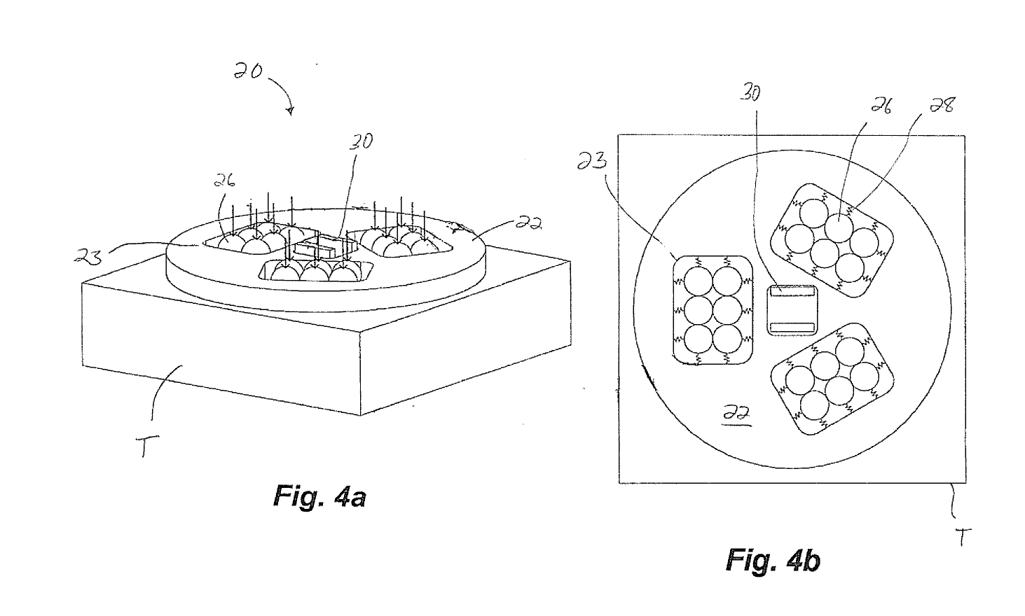

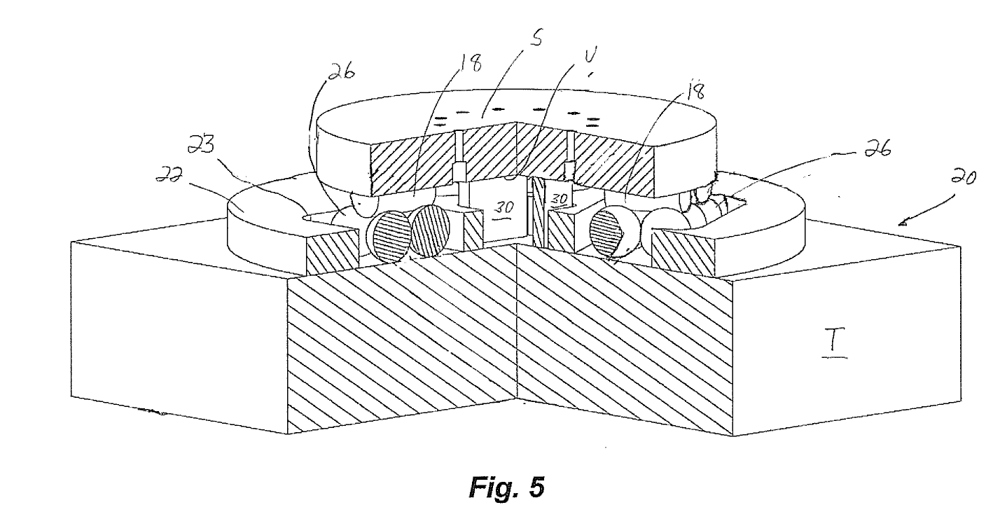

One embodiment is a kinematic coupling (10) that maintains precision and accuracy while being interchangeable with a plurality of tops and bases as illustrated in FIGS. 1a and 1b. An interchangeable kinematic coupling top (12) is fabricated by the template (20) illustrated in FIGS. 2a and 2b. Likewise, an interchangeable kinematic coupling base (14) is fabricated by the template (20) illustrated in FIGS. 4a and 4b. For purposes of this disclosure, a template comprises a device used in creating the top or base of the kinematic or quasi-kinematic coupling.

In this embodiment six points of Hertzian contact are utilized, which necessarily results in the kinematic constraint of the respective base and top; however, more than six points of Hertzian contact could be utilized in an interchangeable quasi-kinematic coupling, thereby increasing the load bearing capacity of the resulting couplings. In order to fabricate interchangeable kinematic coupling bases and tops that maintain accuracy across different base/top pairs, it is necessary to fabricate the interchangeable bases and tops from the same base/top template pairs so that the interchangeable bases and the interchangeable tops are identically replicated to the greatest degree possible.

Forming Kinematic Coupling Top Template

One embodiment of a template (20) for fabricating the kinematic coupling top (12) is illustrated in FIGS. 2a and 2b. The template (20) of this embodiment comprises a frame providing a planar surface (T) (in this embodiment, a granite slab) and a plate (22) (in, this embodiment a steel plate affixed to the granite slab with epoxy and with three approximately circular holes (23)) arranged in a triangle (ideally, an equilateral triangle), and a planar reference structure (30) parallel to the surface (T) (this embodiment uses one or more gage blocks stacked on the granite surface to provide the planar reference structure); supports (26) for locating the top bearing elements (this embodiment uses convex surfaces, such as provided by three sets of three precision steel spheres of substantially equal diameter located in each hole (23) on the plate (22)); three preload elements (28) (this embodiment uses three sets of three spring elements) that serve to position the supports (26) away from the side of the respective hole (23) in the plate (22) and to preload each sphere so that it is in Hertzian contact with each adjacent sphere in a given support.

Equal preloading creates supports (26) each comprised of three spheres arranged in an equilateral triangle. Also, the sizes of the triangles are all sufficiently the same, to the degree the spheres are all the same diameter. Once the supports (26) have been positioned and horizontally preloaded in the holes (23), they are then equally vertically preloaded with a mass, which may comprise a steel plate with an equally distributed mass. Equal preloading creates equal Hertzian deformation at the interface of the supports and the surface (T) and places the centroids of the supports (26) on the same plane, which is also parallel to the planar reference structure (30). After preloading, the supports (26) are and then affixed in position with a fixing agent, such as an epoxy-based of adhesive agent (such as potting compound DP-270, distributed by 3M Industrial Adhesives and Tapes, 3M ID No. 62-3262-1435-0). After affixing the supports (26) to the frame, the template is ready to be used to form a kinematic coupling top (12).

Forming Kinematic Coupling Top from Template

One embodiment of a kinematic coupling top (12) formed from the top template, FIGS. 2a and 2b, is illustrated in FIGS. 1a and 1b. It is comprised of a plate (13) (in this embodiment a circular plate comprised of a hard material, such as steel) with three approximately circular cut-outs, such as through-holes (11) arranged in a sufficiently equal pattern as the holes on the template, three bearing elements (18) of substantially equal size (in this embodiment ultra-precise spheres also formed of a hard material, such as steel) and two work-surfaces (S) and (U) (in this embodiment precision ground surfaces), where the surfaces are substantially parallel to one another.

The fabrication of the kinematic coupling top (12) comprises the steps of placing the kinematic coupling top work surface (U) on the planar reference structure (30), locating each through-hole (11) over the center of the three supports on the template (26), placing a bearing element (18) in each through-hole (11) so that it rests upon one of each of the supports (26), adjusting the plate (13) so that no bearing element (18) is in contact with the plate and each bearing element rests independently upon a support (26), which consists of three spherical shapes. The bearing elements for this embodiment are spherical shapes, and thus have three axes about which the geometry is axisymmetric; therefore to constrain the spheres kinematically, only three points of contact are required. The bearing elements are then equally pre-loaded so that they are in equal Hertzian deformation and, due to the fabrication process of the template, the center of the spherical surface lie on a plane parallel to the work surface (U). The bearing elements are then affixed to the plate with a fixing agent (in this embodiment, epoxy) and the top (12) is ready for use.

In the most preferred embodiment work surfaces (U) and (S) are fabricated so as to be parallel with a plane intersecting the centers of the bearing elements (18). This allows the work surfaces (U) and (S) of a top and base to be parallel when mated, given that the base meets the same criterion.

For parallelism, the spheres on a given top must be of substantially equal diameter, and for accuracy spheres on every top must be of substantially equal diameter. This creates tops that have accurate positioning of the bearing elements and a work surface parallel to the bearing elements. If the positional accuracy in the direction orthogonal to the work surface is not important, which is the case for most applications, the spheres on every top need not be of substantially equal diameter, and then only the spheres on each top need to be of substantially equal diameter.

Forming Kinematic Coupling Base Template

One embodiment of a template (20) for fabricating the kinematic coupling base (14) is illustrated in FIGS. 4a and 4b. This template comprises a frame that contains a surface (T) (in this embodiment a granite slab) and a plate (22) (in this embodiment a steel plate affixed to the granite slab with epoxy and with three approximately rectangular cut-outs, such as through-holes (23)) arranged in an equilateral triangle and the holes are oriented so that one side of the rectangle is substantially parallel to a line drawn from the centroid of the rectangle to the centroid of the triangle comprising the rectangles, and a planar reference structure (30) that is substantially parallel to the surface (T) (in this embodiment gage blocks placed on the granite surface); supports for locating the bearing elements (18) (in this embodiment three sets of six precision steel spheres of sufficiently equal diameter located in each hole on the plate); three preload elements (28) (in this embodiment three sets of ten spring elements) that serve to position the structures comprising the supports (26) away from the side of the respective hole in the plate and to preload each sphere so that it is in Hertzian contact with each adjacent sphere in a given support.

Equal preloading creates supports (26) each comprised of six spheres arranged in an array of two rows and three columns, and the sizes of the arrays are all similar, to the degree the spheres are each the same diameter. Once the elements forming the supports (26) have been positioned and horizontally preloaded in the holes (23), they are then equally vertically preloaded (for this embodiment an equal masses were used). Equal preloading creates equal Hertzian deformation at the interface of the elements of supports (26) and the surface (T) and places the centroids of the supports (26) on the same plane, which is also parallel to the planar reference structure (30). After preloading, the supports (26) are then affixed in position with a fixing agent (such as an epoxy-based adhesive). After affixing the supports (26) to the frame, the template is ready to be used to form a kinematic coupling base (14).

Forming Kinematic Coupling Base from Template

The first embodiment of a kinematic coupling base (14) formed from the base template, FIGS. 4a and 4b, is illustrated in FIGS. 1a and 1b. It is comprised of a plate (13) (in this embodiment a steel plate), three bearing elements (18) of sufficiently equal size (in this embodiment truncated, ultra-precise cylinders arranged to form a vee-groove) and two substantially parallel work-surfaces (S) and (U) (in this embodiment precision ground surfaces that are parallel to one another).

The fabrication of the kinematic coupling base (14) comprises the steps of placing a bearing element (18) so that it rests upon one of the supports (26), placing the kinematic coupling bottom work surface (U) on the planar reference structure (30), and providing the bearing elements (18) so that none is in contact with the plate (13) and each bearing element rests independently upon a support (26). The bearing elements (18) are then equally pre-loaded so that they are in equal Hertzian deformation and, due to the fabrication process of the template, the axes of the cylinders forming the bearing elements (18) lie on a plane parallel to the work surface (U) and the distance between the axes of cylinders on each support (26) is the same. The bearing elements (18) are then affixed to the plate (13) with a fixing agent (in this embodiment, epoxy) and the base is ready for use.

In the most preferred embodiment work-surfaces (U) and (S) are parallel with plane comprising the axes of the cylinders and the cylinders are positioned in an accurate manner. The parallelism is achieved by using cylinders of substantially equal diameter and positioning the two cylinders so that they are equidistant for each bearing element (18). To achieve accurate positioning the cylinders must be of substantially equal diameter and they must be kinematically constrained. Cylinders have one axis about which the geometry is axisymmetric and the surface is straight along that same axis. Therefore, to constrain the cylinders kinematically, only four points of contact are required, which is achieved by the contact of four spherical shapes on the template for forming the base (14). If the positional accuracy in the direction orthogonal to the work surface is not important, which is the case for most applications, the cylinders on every top need not be of substantially equal diameter, and then only the cylinders on each top need to be of substantially equal diameter.

Forming Flippable Kinematic Coupling Top

According to a further aspect of the disclosure, it is also proposed to provide a kinematic coupling in which the top (12) includes bearing elements that project in opposing directions, as shown in FIG. 1a. Specifically, it should be appreciated that, in the preferred embodiment illustrated, the bearing elements (18) in the form of spherical balls associated with the top (12) project from one side of the plate (13) in a first direction and from the opposite side in a generally opposite, second direction. Most preferably, these bearing elements are symmetrical about the plane comprised of the center of the spherical surface of the bearing elements (18), so as to render it capable of being inverted, or flipped, relative to the base (14).

Accordingly, the top (12) in position on a base (14), may be removed, rotated 180° about an axis through the center of the spherical surface of one of the bearing elements (18) and orthogonal to the line comprising the center of the spherical surface of the other two bearing elements (18), and replaced on the same or a different base, as may be desirable for increased efficiency in the course of a particular process. If the triangle is an isosceles triangle with the two equal sides meeting at the bearing element (18) about which rotation occurs, the accuracy of the locations of the spheres is maintained as the top is flipped.

The foregoing descriptions of various embodiments of the invention are provided for purposes of illustration, and are not intended to be exhaustive or limiting. Modifications or variations are also possible in light of the above teachings. For example, although spherical shapes are preferred for use as the bearing elements and template supports (in part because of the highly consistent symmetric nature and ease of ultra-precision fabrication), these may instead comprise other shapes for providing the desired Hertzian contact, such as circular paraboloids.

Additionally, one or more of the bearing elements (18) of the base (14) may be formed using shapes besides cylinders, such as prismatic, gothic arch, or similar structures that present two generally consistent surfaces for engaging and supporting the bearing elements of the top (12) in the manner desired for forming a kinematic coupling. Templates (20) for forming the top (12) and base (14) may also be distributed together or apart from each other. The embodiments described above were chosen to provide the best application to thereby enable one of ordinary skill in the art to utilize the disclosed inventions in various embodiments with various modifications as are suited to the particular use contemplated. All such modifications and variations are within the scope of the invention.

Although the above embodiment contains many specifics, these should not be construed as limiting the scope of the embodiments that are possible. For example, the bearing elements can have shapes so long as they allow for Hertzian constraint of the kinematic elements; the shape of the plate need not be circular; and, the number of Hertzian contacts need not be limited to six, since this method is equally useful for quasi-kinematic couplings and embodiments of quasi-kinematic couplings may be created from the teachings herein.

1. An apparatus for forming a component of a kinematic or quasi-kinematic coupling, the component including a plate adapted for carrying a plurality of bearing elements, comprising:
a template including a plurality of supports adapted for engaging and assisting in aligning the plurality of bearing elements relative to the plate of at least one component of the kinematic coupling.

2. The apparatus of claim 1, wherein the plurality of supports are adapted to be in Hertzian contact with at least one bearing element.

3. (canceled)

4. The apparatus of claim 1, wherein a surface of each support is generally spherical.

5-7. (canceled)

8. The apparatus of claim 1, wherein the supports are adapted to engage a spherical bearing element.

9. (canceled)

10. The apparatus in claim 1, wherein three supports are arranged in a triangle with at least two sides of equal length.

11-17. (canceled)

18. The apparatus of claim 1, further including a planar reference structure for aligning the plate of the component relative to the template.

19. The apparatus of claim 18, wherein the planar reference structure is parallel to a planar structure for engaging the supports.

20. (canceled)

21. An apparatus comprising: a first component for forming a kinematic coupling including a plate having a plurality of bearing elements, each bearing element adapted for engaging at least one of the bearing elements of a second, opposing component, the bearing elements fixed to the plate in a manner that creates parallelism between a work surface on the plate and a plane intersecting the geometric centers of the bearing elements.

22. The apparatus of claim 21, wherein the plurality of bearing elements of the first component is engaged in Hertzian contact with the plurality of bearing elements on the second component.

23. (canceled)

24. The apparatus of claim 21, wherein one or more of the bearing elements include a generally spherical surface.

25-26. (canceled)

27. The apparatus of claim 21, wherein the geometric centers of the plurality of bearing elements form a triangle with at least two sides of equal length.

28. The apparatus of claim 21, wherein at least one of the bearing elements protrudes from the plate in two generally opposing directions.

29. The apparatus of claim 28, wherein one or more of the bearing elements protrude symmetrically from the plate about a plane parallel to the work surface.

30-36. (canceled)

37. A method for forming a component for forming a kinematic or quasi-kinematic coupling, the component having a plate adapted for carrying a plurality of bearing elements, comprising:
providing a template including a plurality of supports adapted for assisting in aligning the plurality of bearing elements relative to the plate of the component; and
fixing the bearing elements to the plate.

38. The method of claim 37, wherein the component comprises a first component, and further including the step of using the template to align the plurality of bearing elements relative to the plate of a second kinematic component.

39-40. (canceled)

41. The method of claim 37, further including establishing Hertzian contact between the plurality of supports and the plurality of bearing elements.

42. (canceled)

43. The method of claim 37, further including engaging the supports with a generally spherical bearing element.

44-45. (canceled)

46. The method of claim further including the step of arranging the supports in a triangle with at least two sides of equal length.

48-50. (canceled)

51. The method of claim 37, further including the step of arranging a surface on the plate in parallel with the plane comprising the geometric center of the bearing elements.

52. The method of claim 37, further including the step of aligning the plurality of bearing elements by placing the bearing elements in Hertzian contact with the plurality of supports.

53-58. (canceled)
